(19) United States
(12) Patent Application Publication
(10) Pub. No.: US 2010/0170424 A1
(43) Pub. Date: Jul. 8, 2010

(54) ANCHORING BASE FOR FIXING BANKING EQUIPMENTS

(75) Inventor: Nelson Tavares De Pinho, San Paulo (BR)

Correspondence Address: LEWIS, BRISBOIS, BISGAARD & SMITH LLP, 221 NORTH FIGUEROA STREET, SUITE 1200, LOS ANGELES, CA, 90012, US

(73) Assignee: TECNOLOGIA BANCARIA S.A., Sao Paulo (BR)

(21) Appl. No.: 12/298,983

(22) PCT Filed: Nov. 19, 2007
(86) PCT No.: PCT/BR2007/000311

§ 371 Date: Feb. 19, 2009

(30) Foreign Application Priority Data
Jun. 29, 2007 (BR) PI 0702143-7

(51) Int. Cl. E05G 1/02; E05G 1/00

(52) U.S. Cl. 109/50

(57) ABSTRACT

“ANCHORING BASE FOR FIXING BANKING EQUIPMENTS”, presents a base for anchoring for fixing banking equipment that essentially comprises a metallic plate, a kit for fixing the base on the ground, and one kit for fixing banking equipment to the referred metallic plate; one of the main functions of the anchoring base for fixing banking equipments is to avoid the leverage of banking equipment; by using the anchoring base for fixing banking equipments, object of the present patent of Privilege of Invention, the protection of the referred banking equipments is much higher.

### FIELD OF INVENTION

The present patent of Privilege of Invention refers to an anchoring base used for fixing banking equipments of ATM-like, as well as equipments for money supplying also known as Cash Dispenser.

### BACKGROUND OF THE INVENTION

It if common knowledge that banking institutions have been making available to customers for several years a set of facilities and, among them, there are the ATMs, which refer to installations wherein may be executed several types of banking operations, one of the main, the money withdrawn.

The banking institutions make also available equipments known as Cash Dispenser which allow money withdrawn and other operations, and may be mounted in locals of great public circulation.

In general, both ATM-like installations and Cash Dispenser present a structure that must offer protection against casualty attempts.

Recently, the violence techniques which the gangs specialized in robberies and ATM violation and Cash Dispenser have been acted ends up proving that the referred means of protection must be reformulated.

### BRIEF DESCRIPTION OF THE INVENTION

Aiming to solve the problems hereinabove mentioned, the present patent of Privilege of Invention of was developed.

The anchoring base for fixing banking equipments now referred comprises in essence, a metallic plate, a kit for fixing the base on the ground and a kit for fixing the banking equipment to the referred metallic plate.

By using the anchoring base for fixing banking equipments, object of the present patent of Privilege of Invention, the protection of the referred banking equipments is much higher.

### BRIEF DESCRIPTION OF THE FIGURES

The present patent of Privilege of Invention will be described in details based on the figures herein below mentioned, which:

FIG. 1 illustrates in exploded perspective the metallic plate, as well as the kits for fixing and a generic banking equipment;

FIG. 2 illustrates an upper view of the metallic plate;

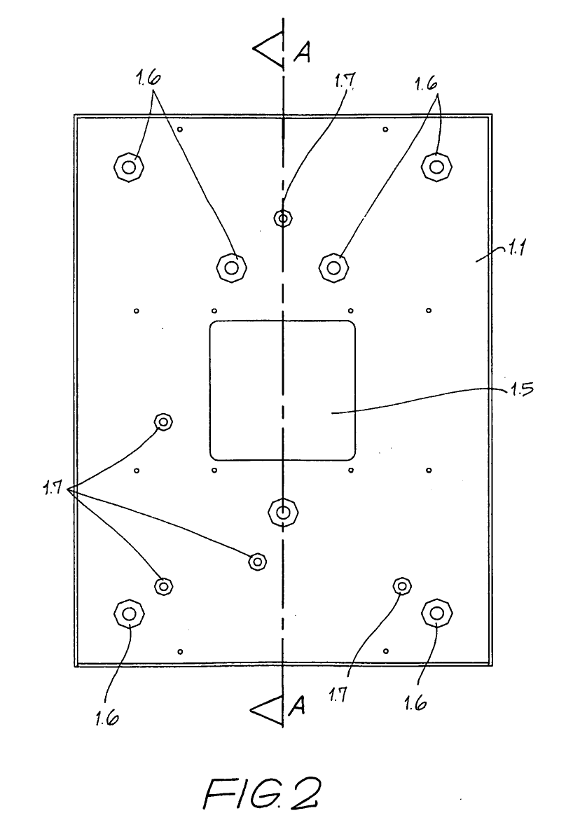

FIG. 3 illustrates a frontal view of the metallic plate;

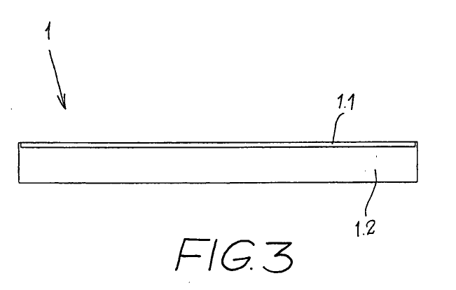

FIG. 4 illustrated the cut A-A from FIG. 2; and

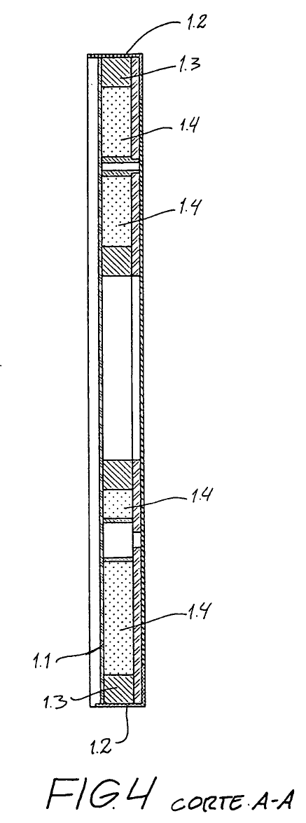

FIG. 5 illustrates in exploded perspective the metallic plate used for anchoring a banking equipment with a side reinforcement and the respective banking equipment with side reinforcement.

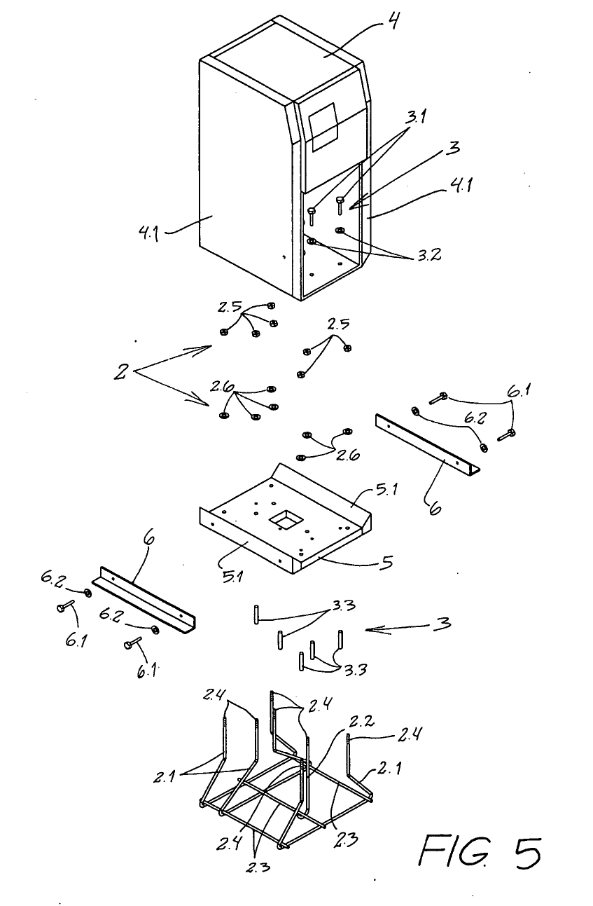

### DETAILED DESCRIPTION OF THE INVENTION

The base for anchoring for fixing banking equipment as previously mentioned, is composed by a metallic plate 1, by a kit 2 for fixing the metallic plate 1 on the ground, and a kit 3 for fixing banking equipments 4 in the metallic plate 1.

The metallic plate 1 has an essential rectangular shape and comprises an upper lid 1.1 and a box 1.2.

Between the lid 1.1 and the box walls 1.2 there are solid squared tubes 1.3 and all remaining interspace is filled with armed concrete 1.4.

Note also that the metallic plate 1 has a passing cut 1.5 and this cut is centralized and has an essential squared format. The referred metallic plate 1 counts also with passing holes 1.6 and passing holes 1.7.

It is also important to emphasize that the armed concrete 1.4 has cement, koridon and dramix in specific amounts. The concrete 1.4 provides protection against blowtorches, drilling machines, and hand drills attacks.

The kit for fixing the metallic plate 1 on the ground is referred by indication 2, and comprises a set of metallic hardware in essential trapezium shape 2.1, umbrella handle 2.2 and smooth bars 2.3. It is important to mention the upper edges of all metallic hardware present spindles 2.4.

The kit 2 also comprises nuts 2.5 and washers 2.6 contemplated to be used together with spindles 2.4.

The kit for fixing banking equipments 4 in the metallic plate 1 is referred by indication 3, and comprises a set of screws 3.1 with resistance class superior to conventional steel resistance class, a set of washers 3.2 and a set of pipes 3.3 which are parts composed by a nut welded in a tube having close bottom. The pipes 3.3 are positioned lower the metallic plate 1, and they are used to protect the screw threads 3.1.

For installing the anchoring base for fixing banking equipments in a generic banking equipment 4 is needed to fix the hardware 2.1, 2.2, and 2.3 from kit 2 to the ground. The metallic plate 1 is coupled to the bridges of the respective hardware 2.1, 2.2 and 2.3, that obviously stay out of the ground, by means of the passing holes 1.6. Following, the washers 2.6 are introduced in the edges of the hardware now mentioned, and the nuts 2.5 are thread in the holes 2.4, thus locking the metallic plate 1 to the ground.

After, the generic banking equipment 4 is coupled to the metallic plate 1 through screws 3.1, wherein they are fixed to the said metallic plate 1 through passing holes 1.7.

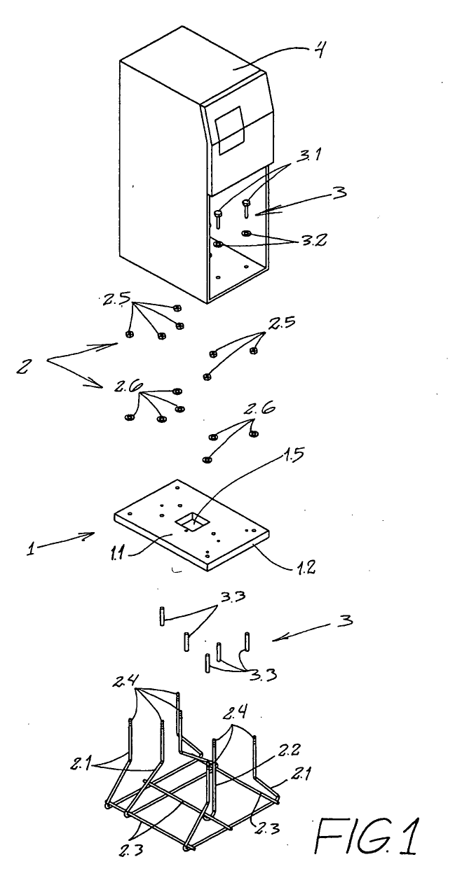

This installation, and the disposition of the elements is better understood through FIG. 1 analysis.

It is also important to mention that the metallic plate 1 can be fixed to the ground through a chemical anchoring, dismissing, then, all kit 2.

It is important to emphasize that, when the banking equipment 4 presents side reinforcement 4.1 (adjacent side walls), it is used a metallic plate 5 similar to the metallic plate 1, however, such metallic plate 5 has two transversal horizontal side tails 5.1 of reinforcement, such tails that are filled by armed concrete 1.4. In this case, leveling corners 6 are used, being fixed on the side of the metallic plate 5 through screws and washers 6.1 and 6.2, respectively.

One of the main functions of the anchoring base for fixing banking equipments is to avoid the leverage of banking equipment 4.

Based on the above-mentioned context, it is evident observing that the anchoring base for fixing banking equipments, object of the present patent of Privilege of Invention, proposes an absolute simple and efficient alternative for protecting banking equipment ATM-like and Cash Dispensers.

1. “ANCHORING BASE FOR FIXING BANKING EQUIPMENTS”, characterized by the fact of being composed by a metallic plate (1), by a kit (2) for fixing the metallic plate (1) on the ground, and a kit (3) for fixing banking equipments (4) in the metallic plate (1); the metallic plate (1) has an essential rectangular shape and comprises an upper lid (1.1) and a box (1.2); between the lid (1.1) and the box walls (1.2) there are solid squared tubes (1.3) and all remaining interspace is filled with armed concrete (1.4); the metallic plate (1) has a passing cut (1.5), and this cut is centralized and has an essential squared format; the referred metallic plate (1) counts also with passing holes (1.6) and passing holes (1.7); the kit (2) for fixing the metallic plate (1) on the ground comprises a set of metallic hardware in essential trapezium shape (2.1), umbrella handle (2.2) and smooth bars (2.3); it is important to mention the upper edges of all metallic hardware present spindles (2.4); the kit (2) also comprises nuts (2.5) and washers (2.6) contemplated to be used together with spindles (2.4); the kit (3) for fixing banking equipments (4) in the metallic plate (1) comprises a set of screws (3.1), a set of washers (3.2) and a set of pipes (3.3) which are parts composed by a nut welded in a tube having close bottom; the pipes (3.3) are positioned lower the metallic plate (1) and they are used to protect the screw threads (3.1).

2. “ANCHORING BASE FOR FIXING BANKING EQUIPMENTS”, according to claimed in 1, characterized BANKING EQUIPMENTS”, according to claimed in 1, characterized by the fact that the armed concrete (1.4) has cement, koridon and dramix in specific amounts.

3. “ANCHORING BASE FOR FIXING BANKING EQUIPMENTS”, according to claimed in 1, characterized by the fact that the screws (3.1) are screws with resistance class superior to conventional steel resistance class.

4. “ANCHORING BASE FOR FIXING BANKING EQUIPMENTS”, according to claimed in 1, characterized by the fact that the hardware (2.1), (2.2), and (2.3) from kit (2) are fixed to the ground; the metallic plate (1) is coupled to the bridges of the respective hardware (2.1), (2.2), and (2.3), that stay out of the ground, by means of the passing holes (1.6); following, the washers (2.6) are introduced in the edges of the hardware now mentioned, and the nuts (2.5) are thread in the holes (2.4), thus locking the metallic plate (1) to the ground; after, the generic banking equipment (4) is coupled to the metallic plate (1) through screws (3.1), wherein they are fixed to the said metallic plate (1) through passing holes (1.7).

5. “ANCHORING BASE FOR FIXING BANKING EQUIPMENTS”, according to claimed in 1 and 4, characterized by the fact that the metallic plate (1) can be fixed to the ground through a chemical anchoring, dismissing, then, all kit (2).

6. “ANCHORING BASE FOR FIXING BANKING EQUIPMENTS”, according to claimed in 1, characterized by the fact that contemplating a metallic plate (5) similar to the metallic plate (1), but also having horizontal side tails (5.1) of reinforcement, the referred metallic plate (5) is used when the banking equipment (4) present side reinforcement (4.1); in this case, leveling corners (6) are used, being fixed on the side of the metallic plate (5) through screws and washers (6.1) and (6.2), respectively.
